(19) United States
(12) Patent Application Publication
(10) Pub. No.: US 2014/0307651 A1
(43) Pub. Date: Oct. 16, 2014

(54) Internet Protocol Address Registration

(71) Applicant: Futurewei Technologies, Inc., Plano, TX (US)

(72) Inventors: Behcet Sarikaya, Wylie, TX (US); Marco Spini, Boulogne-Billancourt (FR)

(73) Assignee: Futurewei Technologies, Inc., Plano, TX (US)

(21) Appl. No.: 14/251,272

(22) Filed: Apr. 11, 2014

Related U.S. Application Data
(60) Provisional application No. 61/811,178, filed on Apr. 12, 2013.

(51) Int. Cl. H04L 29/12; H04W 76/02

(52) U.S. Cl. CPC H04L 61/2007; H04W 76/021
USPC 370/329

(57) ABSTRACT

A computer program product implemented in an Internet Protocol (IP) edge node positioned in a fixed access network, the computer program product comprising computer executable instructions stored on a non-transitory computer readable medium such that when executed by a processor cause the IP edge node to receive an address registration request from a residential gateway (RG), wherein the address registration request comprises an IP version six (IPv6) address of a third Generation Partnership Project (3GPP) visiting mobile host connected to a local fixed network associated with the RG and a host identifier (ID) assigned to the visiting host and not to any other host in the local fixed network; establish an IP Connectivity Access Network (IP-CAN) session for the visiting host; and manage quality of service (QoS) for the visiting host independently of other hosts in the local fixed network by managing the visiting host IP-CAN session.

### CROSS-REFERENCE TO RELATED APPLICATIONS

The present application claims priority to U.S. Provisional Patent Application 61/811,178 filed Apr. 12, 2013 by Behcet Sarikaya and Marco Spini and entitled “IPv6 Prefix Sharing Protocol,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The proliferation of Internet capable devices and the varied nature of user interaction with such devices has significantly complicated traditional network communication paradigms. For example, fixed hosts such as desktop personal computers (PCs), laptop/tablet PCs, set top boxes, game consoles, etc., may connect with a service provider via physical and/or a combination of physical and local wireless connections. Meanwhile, mobile hosts, such as mobile phones, laptop/tablet PCs, etc., may also be equipped with the capability of communicating directly with a service provider via a wireless connection. Further, mobile devices may swap between wireless connection types and/or physical connections based on user need. Such roaming between networks and network types may lead to complications in maintaining expected service for the mobile hosts.

### SUMMARY

In one embodiment, the disclosure includes a method implemented in a residential gateway (RG) positioned in a local fixed network. The method may comprise obtaining an Internet Protocol (IP) version six (IPv6) prefix for the RG. The RG may then receive an address request from a visiting 3rd Generation Partnership Project (3GPP) mobile host. The RG may allocate an IPv6 address to the visiting host based on the IPv6 prefix. The RG may transmit an address registration request to an IP edge node on behalf of the visiting host. The address registration request may comprise the IPv6 address of the visiting host and a host identifier (ID) assigned to the visiting host. The host ID may not be assigned to any other host in the local fixed network.

In another embodiment, the disclosure includes a computer program product implemented in an IP edge node positioned in a fixed access network, such as a Broadband Forum (BBF) access network. The computer program product may comprise computer executable instructions stored on a non-transitory computer readable medium such that when executed by a processor cause the IP edge node to receive an address registration request from an RG. The address registration request may comprise an IPv6 address of a visiting 3GPP mobile host connected to a local fixed network associated with the RG and a host ID assigned to the visiting host and not to any other host in the local fixed network, such as other visiting and/or local 3GPP mobile hosts. The information in the address registration request may also comprise a circuit ID and/or a Media Access Control (MAC) address. The IP edge node may establish an IP Connectivity Access Network (IP-CAN) session for the visiting host, and manage quality of service (QoS) for the visiting host independently of other hosts in the local fixed network by managing the mobile host IP-CAN session.

In another embodiment, the disclosure includes a method implemented in an edge router. The edge router may act as a Broadband Network Gateway (BNG). The method may comprise assigning an IPv6 prefix to a routed RG. The method may authenticate a 3GPP host connected to the RG with a 3GPP network in order to receive a host ID from the 3GPP network. The method may receive, from the RG, an address registration request message comprising an IPv6 address of the 3GPP host based on the IPv6 prefix and the host ID. The IPv6 addresses of all hosts connected to the RG may all be based on the prefix that is assigned to the RG. After address registration, the method may communicate with a Policy and Charging Rules Function (PCRF) server to get separate Quality of Service (QoS) parameters for each host connected to the RG by establishing an IP Connectivity Access Network (IP-CAN) sub-session for each host as part of a main IP-CAN session between the RG and the PCRF server. The method may then enforce QoS in active traffic for each host connected to the RG.

In another embodiment, the disclosure includes a method implemented in a residential RG positioned in a local fixed network, such as an IP version four (IPv4) network. The RG may receive a communication from a host connected to the local fixed network, wherein the communication is directed toward a server in an upstream network. The RG may forward the communication toward the server by employing an IP address associated with RG as the source of the communication, for example when the RG employs network address translation (NAT) to maintain an IPv4 address space. The RG may then transmit an address registration request, separate from the host communication, to the server to register an IP address of the host with the server. The address registration request may comprise the host IP address and an identifier associated with the host, such as a subscription ID of the host. By forwarding the IP address of the host, the server may be capable of managing traffic to the host by employing different policies than the policies used for other hosts associated with the RG, for example when the host makes an emergency call, etc.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a network comprising a local network coupled to a mobile core network via a fixed access network.

FIG. 2 is a schematic diagram of an embodiment of a network element (NE) within a network.

FIG. 3 is a protocol diagram of an embodiment of a method of RG authentication.

FIG. 4 is a protocol diagram of an embodiment of a method of IP-CAN session establishment for a mobile host based on host authentication.

FIG. 5 is a protocol diagram of an embodiment of a method of IP-CAN session establishment for a mobile host performed without host authentication.

FIG. 6 is a protocol diagram of an embodiment of a method of IP-CAN session establishment for a mobile host performed via a Broadband Policy Control Framework (BPCF) Policy Decision Point (PDP) node.

FIG. 7 is a protocol diagram of an embodiment of a method of IP-CAN session termination by an RG.

FIG. 8 is a protocol diagram of an embodiment of a method of IP-CAN session termination by an IP edge node.

FIG. 9 is a protocol diagram of an embodiment of a method of IP-CAN session termination by a Policy and Charging Rules Function (PCRF) node.

FIG. 10 is a protocol diagram of an embodiment of a method of IP-CAN session/sub-session modification.

FIG. 11 is a schematic diagram of an embodiment of an address registration request type length value (TLV) encoding.

FIG. 12 is a schematic diagram of an embodiment of an address parameter TLV encoding.

FIG. 13 is a schematic diagram of an embodiment of a host ID parameter TLV encoding.

FIG. 14 is a schematic diagram of an embodiment of an address registration reply TLV encoding.

FIG. 15 is a protocol diagram of an embodiment of a method of IPv4/IPv6 address sharing.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Roaming mobile hosts may result in administrative challenges from the network perspective. For example, a mobile host may connect wirelessly to a 3GPP network via a base station. A service provider of the 3GPP network may agree to provide a particular level of service to the owner of the mobile host, for example via a service level agreement (SLA). Meanwhile, a fixed network, such as a home network, a business local area network (LAN), etc., may connect to the same or a different service provider via a residential gateway (RG). The agreed upon level of service for the fixed network may be different than the agreed upon level of service for the mobile host. However, the mobile host may be configured to roam from the mobile network and connect via the home network. Further, additional mobile hosts with still different agreed upon levels of service may also connect to the home network. In such a scenario, there may be no adequate mechanism to maintain separate service levels for all the mobile devices connected via the fixed network.

Disclosed herein is a mechanism for maintaining separate QoS requirements for a plurality of mobile hosts with different service levels connected via the same fixed network. The RG may separately register a host ID for each coupled host with an IP edge node positioned in a fixed access network. The IP edge node may then establish an IP-CAN session for each registered device. In addition or in the alternative, the IP edge may establish a single IP-CAN session for all devices connected to the RG and create IP-CAN sub-sessions for each connected device. The IP-CAN sessions/sub-sessions for each host may be managed independently. When an IP-CAN session/sub-session is established for a mobile host, the QoS requirements for the mobile host may be obtained from the host's mobile network. The IP edge node may then maintain separate QoS for the plurality of hosts connecting from the same local network by independently managing each IP-CAN session/sub-session. Further, such IP-CAN session/sub-session may be independently modified and/or terminated based on changing conditions, such as mobile host disconnects, further roaming, loss of power, etc.

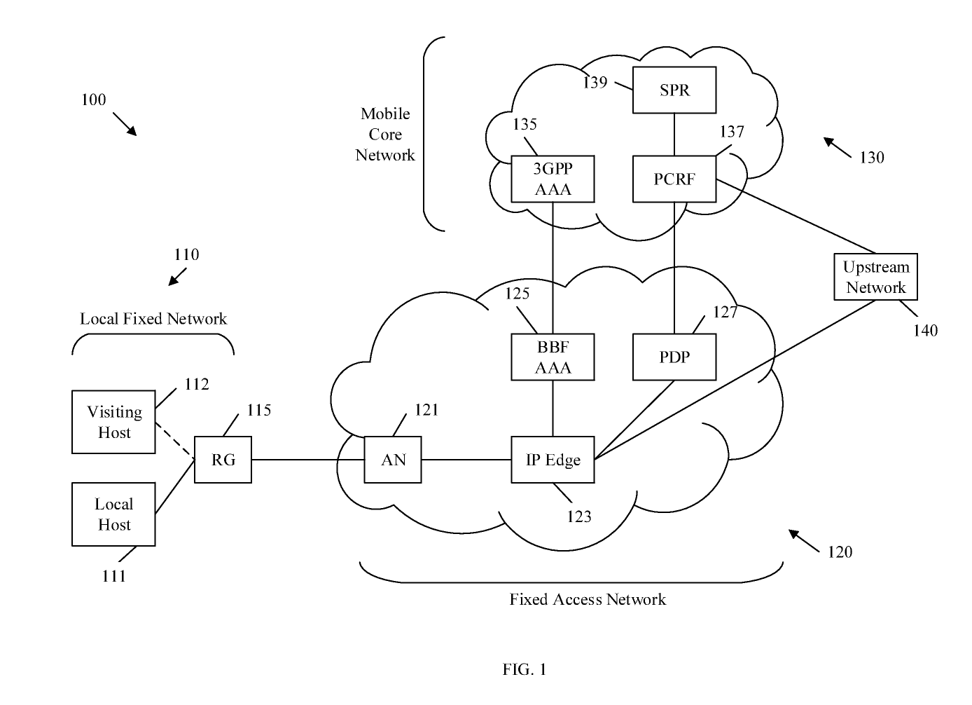

FIG. 1 is a schematic diagram of an embodiment of a network 100 comprising a local network 110 coupled to a mobile core network 130 via a fixed access network 120. Local network 110 may comprise a local host 111 and a visiting host 112 coupled to an RG 115. Fixed access network 120 may comprise an access node (AN) 121, an IP edge 123 node, a BBF Authentication, Authorization, and Accounting (AAA) 125 node, and a PDP 127 node. Mobile core network 130 may comprise a 3GPP AAA 135 node, a PCRF 137 node, and a Subscription Profile Repository (SPR) 139 node. The components of the fixed access network 120 may communicate with components in the mobile core network 130 to provide components in the local network 110 appropriate access to an upstream network 140, such as the Internet, applications, or other services offered by the core network. Further, by communicating with both the RG 115 and/or the PRCF 137, the IP edge 123 may obtain distinct QoS parameters for visiting host 112 and may enforce QoS for visiting host 112 separately from local host 111.

Local network 110 may comprise a residential network, a commercial network, a LAN, and/or any network that may access a core network via an access network. The RG 115 may be a cable modem, router, wireless router, coaxial terminal, optical terminal, and/or combinations thereof. The RG 115 may maintain an address space for the local network 110 and may act as an access point to the fixed access network 120 for any local network 110 components. The RG 115 may perform any appropriate network address translation (NAT) functions, obtain network prefixes (e.g. IPv6 network prefixes), assign network addresses (e.g. IPv6 network addresses) to local network 110 components, perform routing functions, and/or register local network 110 components with upstream networks. RG 115 may also be referred to as a gateway and/or a customer premises equipment (CPE) for commercial (e.g. non-residential) networks. RG 115 may also be an IPv6 device and/or a dual stack (DS) device that also supports an IP version four (IPv4) address scheme. Local host 111 may connect to the upstream networks via the RG 115. Local host 111 may also be referred to as a host and/or local host. Local host 111 may be any wired and/or wireless end user device configured to connect to the network, such as a personal computer (PC), laptop, tablet PC, set-top box, game console, smart phone, etc. In some embodiments, the local host 111 may also be a 3GPP device that may natively connect to the mobile core network 130. Visiting host 112 may be any device that may natively connect to the mobile core network 130 (e.g. via a base station) on a first interface and may also connect to the local network 110 on a second interface (e.g. via Bluetooth, wireless LAN (WLAN) interface, Ethernet connection, etc.). Visiting host 112 may also be referred to as a host, visiting host, roaming host, etc. In an embodiment, the visiting host 112 may comprise a 3GPP device, such as a smart phone. In FIG. 1, visiting host 112 is connected to RG 115 with a dashed line to indicate a wireless connection, and local host 111 is connected to RG 115 with a solid line to indicate a wired connection. However, it should be noted that either device may connect to the RG wirelessly and/or via a wired connection in certain specific embodiments.

Fixed access network 120 may be any access network configured to support communication between the local network 110, the mobile core network 130, and/or the upstream network 140, such as a digital subscriber line (DSL) network, optical network, coaxial network, etc. For example, the fixed access network may be a BBF network as discussed in BBF documents technical report (TR)-134, TR-203, and working text (WT)-300, all of which are incorporated herein by reference as if reproduced in their entirety. AN 121 may be any gateway node (e.g. gateway, server, etc.) in network 120 coupled to and/or configured to communicate with RG 115 in order to provide access to network 120 from network 110. IP edge 123 may be any node or group of nodes configured to provide access to the IP core networks and manage QoS and/or Quality of Experience (QoE) for end users, such as visiting host 112, local host 111, etc. IP edge 123 may also be referred to as a BNG and/or a Policy and Charging Enforcement Function (PCEF) node in some embodiments. BBF AAA 125 may be any node (e.g. server) configured to provide AAA service for network 120, such as providing security, access management, and tracking of network 120 resource use by end user nodes, such as visiting host 112 and/or local host 111. BBF AAA 125 may employ Remote Authentication Dial In User Service (RADIUS) protocol, diameter protocol, and/or similar protocols to provide AAA functionality, as such protocols are discussed in IETF documents request for comments (RFC) 2865 and RFC 4072, both of which are incorporated by reference. PDP 127, which may also be referred to as a BPCF node, may be any node (e.g. server) configured to make policy decisions for end users. For example, the PDP 127 may maintain network policy and/or user policies, may accept policy queries from a policy enforcement point such as IP edge 123, and may accept or deny such queries based on the stored policies. For example, the PDP 127 may provide IP Edge 123 with QoS parameters for end user nodes on request.

Mobile core network 130 may be any network configured to provide mobile devices with wireless access to core network functions, for example via third generation (3G) wireless technology, fourth generation (4G) Long Term Evolution (LTE) wireless technology, etc. For example, mobile core network 130 may be 3GPP based network as defined in 3GPP documents 3GPP technical specifications (TS) 23.139 v 12.0.0, 3GPP TS 23.203 v 12.3.0, 3GPP TS 29.212 v 12.3.0, 3GPP TS 29.213 v 12.2.0, all of which are incorporated herein by reference as if reproduced in their entirety. 3GPP AAA 135 may be substantially similar to BBF AAA 125, and may provide similar AAA services for network 130. PCRF node 137 may be similar to PDP node 127, and may provide similar policy decision services for network 130. SPR 139 may also be referred to as a user data repository (UDR). SPR 139 may maintain information regarding particular user's subscriber information, such as allowed services, QoS information priority information, etc. The PCRF node 137 may query SPR 139 to obtain such subscriber information when making policy decisions when a host that is native to mobile core network 130 (e.g. visiting host 112) requests wireless accesses (e.g. 3G 4G, etc.) to network 130 resources. In Fixed Mobile Convergent scenario, when both mobile core network 130 and fixed access network 120 are deployed by the same network operator, the PCRF 137 may be connected directly to IP Edge 123 and the functions of PDP 127 may be performed by PCRF 137.

In some embodiments, RG 115 may allocate all host addresses and may not register such addresses with the IP edge 123. In such an embodiment, the IP edge 123 maintains QoS for all nodes in local network 110 by querying PDP 127 for policy decisions related to RG 115 and/or by creating a single IP-CAN session to obtain a single set of subscription parameters for all hosts connected to RG 115. In such an embodiment, the IP edge 123 may be limited to maintaining a single QoS for all hosts attaching to RG 115 regardless of variations of host service levels.

In an alternate embodiment, RG 115 may register all hosts (e.g. visiting host 112 and local host 111) with the IP edge 123 by transmitting an IP address of each host (e.g. IPv6 address) and a host ID specific to each host. By employing the IPv6 address and host ID, the IP edge 123 may apply different policies (e.g. QoS) to each host. The IP edge 123 may then create a separate IP-CAN session for each host and/or create a IP-CAN session for the RG 115 and a sub-session for each host. By employing the IPv6 address of each host, the host ID of each host, and a line ID associated with the RG 115, the IP edge 123 may obtain different parameters for each host (e.g. visiting host and local host), may associate such parameters to RG 115 by line ID, and may employ the parameters obtained from network 130 when applying different policies for each host.

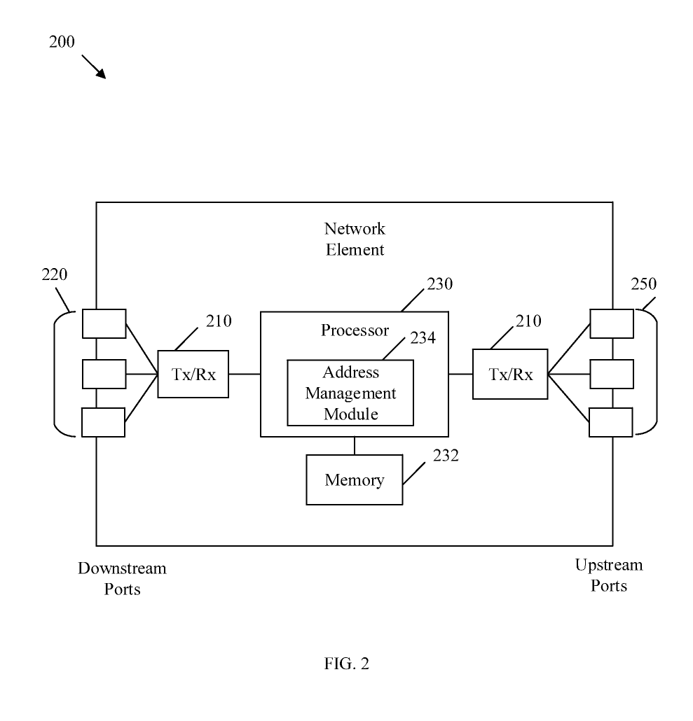

FIG. 2 is a schematic diagram of an embodiment of a network element (NE) within a network, such as an IP edge 123 or an RG 115. In some embodiments, NE 200 may be any component in network 100. For example, NE 200 may be configured to register host addresses when implemented as an RG 115, and may be configured to establish IP-CAN sessions for hosts when implemented as an IP edge. NE 200 may be implemented in a single node or the functionality of NE 200 may be implemented in a plurality of nodes. One skilled in the art will recognize that the term NE encompasses a broad range of devices of which NE 200 is merely an example. For example, when operating a host, NE 200 may comprise an antenna coupled to and/or instead of one or more of the ports 250/220. NE 200 is included for purposes of clarity of discussion, but is in no way meant to limit the application of the present disclosure to a particular NE embodiment or class of NE embodiments. At least some of the features/methods described in the disclosure may be implemented in a network apparatus or component such as an NE 200. For instance, the features/methods in the disclosure may be implemented using hardware, firmware, and/or software installed to run on hardware. The NE 200 may be any device that transports frames through a network, e.g., a switch, router, bridge, server, a client, etc. As shown in FIG. 2, the NE 200 may comprise transceivers (Tx/Rx) 210, which may be transmitters, receivers, or combinations thereof. A Tx/Rx 210 may be coupled to a plurality of downstream ports 220 (e.g. downstream interfaces) for transmitting and/or receiving frames from other nodes and a Tx/Rx 210 coupled to a plurality of upstream ports 250 (e.g. upstream interfaces) for transmitting and/or receiving frames from other nodes, respectively. A processor 230 may be coupled to the Tx/Rxs 210 to process the frames and/or determine which nodes to send frames to. The processor 230 may comprise one or more multi-core processors and/or memory devices 232, which may function as data stores, buffers, etc. Processor 230 may be implemented as a general processor or may be part of one or more application specific integrated circuits (ASICs) and/or digital signal processors (DSPs). Processor 230 may comprise an address management module 234, which may implement the methods discussed herein such as registering host addresses, establishing IP-CAN sessions/sub-sessions with a 3GPP network, terminating IP-CAN sessions/sub-sessions, modifying IP-CAN sessions/sub-sessions, managing QoS, etc. In an alternative embodiment, the address management module 234 may be implemented as instructions stored in memory 232, which may be executed by processor 230, or implemented in part in the processor 230 and in part in the memory 232. In another alternative embodiment, the address management module 234 may be implemented on separate NEs. The downstream ports 220 and/or upstream ports 250 may contain electrical and/or optical transmitting and/or receiving components.

It is understood that by programming and/or loading executable instructions onto the NE 200, at least one of the processor 230, address management module 234, Tx/Rxs 210, memory 232, downstream ports 220, and/or upstream ports 250 are changed, transforming the NE 200 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

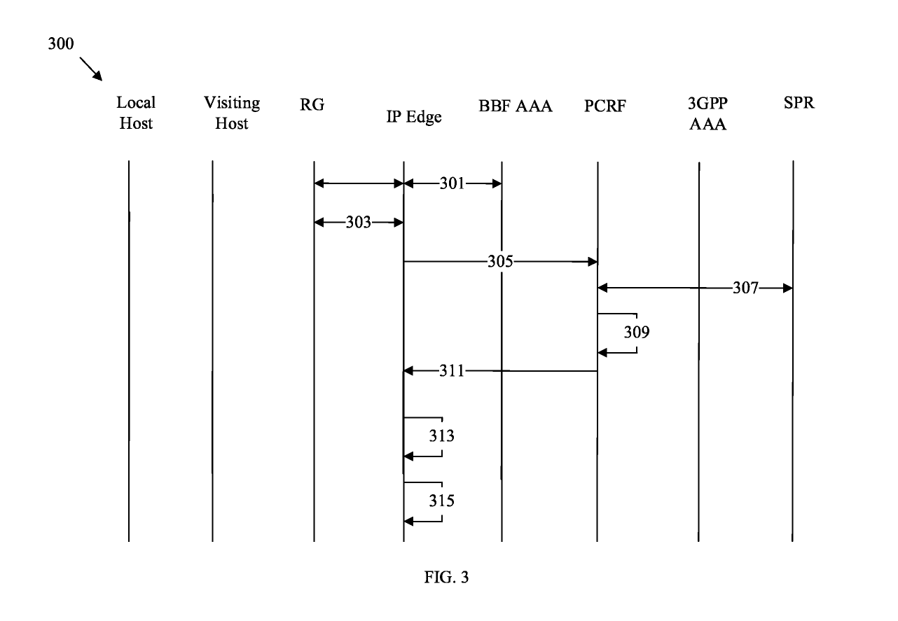

FIG. 3 is a protocol diagram of an embodiment of a method of RG authentication, which may be implemented in a network such as network 100. For example, method 300 may be employed by a network comprising a local host, a visiting host, an RG, an IP edge, a BBF AAA, a PCRF, a 3GPP AAA, and an SPR, which may be substantially similar to local host 111, visiting host 112, RG 115, IP edge 123, BBF AAA 125, PCRF 137, 3GPP AAA 135, and SPR 139, respectively. Method 300 may be employed to initialize a connection between an RG and an IP edge, for example prior to establishing a connection between the RG and any hosts in a local network. At step 301, the RG may communicate with the IP edge, and the IP edge may authenticate the RG with the BBF AAA. At step 303, the IP edge may allocate an IPv6 prefix to the RG for use in creation of an IPv6 address space in the local network. At step 305, the IP edge may transmit a message to the PCRF to request the establishment of an IP-CAN session for the RG. The session establishment message of step 305 may comprise the assigned IPv6 prefix and a subscriber ID associated with the RG. The subscriber ID may be an ID of a line between the RG and the IP edge, an ID associated with the RG and received during the authentication of step 301, or any other ID that uniquely identifies the RG. At step 307, the PCRF may obtain, from the SPR, a subscriber profile and/or a fixed access line profile associated with the RG. Based on the profiles obtained at step 307 and/or policies stored on the PCRF, at step 309 the PCRF may make a policy decision regarding the IP-CAN session establishment request of step 305. At step 311, the PCRF may transmit an acknowledgment message to the IP edge to indicate a successful establishment of an IP-CAN session for the RG. The acknowledgment message may comprise the subscriber ID and/or IPv6 prefix of step 305 as well as any management parameters related to the IP-CAN session, such as QoS requirements. At step 313, the IP edge may bind an IP Subscriber Session for the RG with the IP-CAN session identified by the subscriber ID and/or prefix transmitted/received at steps 305 and/or 311. At step 315, the IP edge may begin to perform admission control and/or policy enforcement (e.g. QoS enforcement) for the RG, for example by managing the IP-CAN session for the RG.

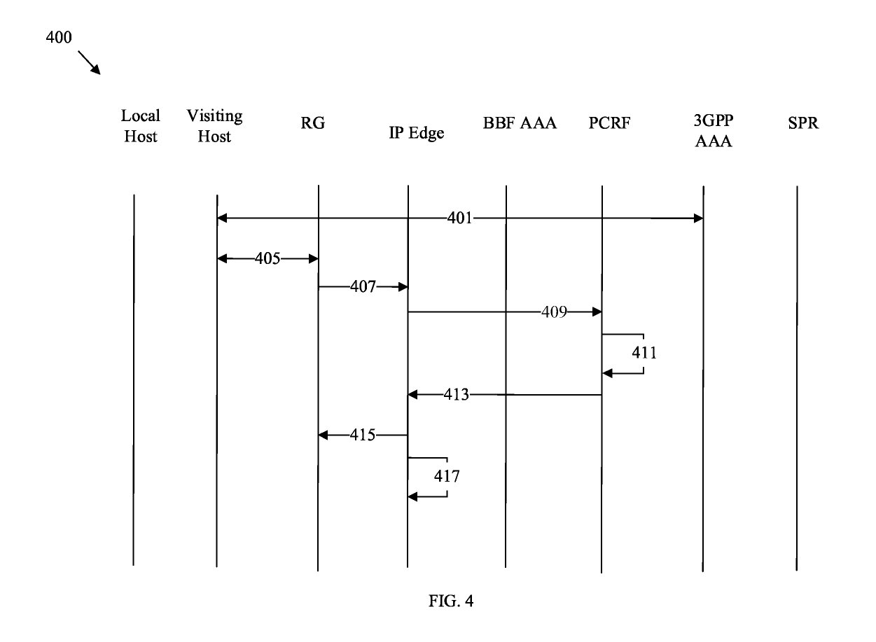

FIG. 4 is a protocol diagram of an embodiment of a method of IP-CAN session establishment for a visiting host based on host authentication, which may be implemented in a network such as network 100. For example, method 400 may be employed by a network comprising a local host, a visiting host, an RG, an IP edge, a BBF AAA, a PCRF, a 3GPP AAA, and an SPR, which may be substantially similar to local host 111, visiting host 112, RG 115, IP edge 123, BBF AAA 125, PCRF 137, 3GPP AAA 135, and SPR 139. Method 400 may occur after method 300, respectively. At step 401, a visiting host, which may be a 3GPP host, may attach to the RG and may perform authentication with the 3GPP AAA node in the mobile core network (e.g. via the RG and IP edge). For example, the 3GPP AAA may authenticate the visiting host by employing Extensible Authentication Protocol (EAP)-Authentication and Key Agreement (AKA) signaling, EAP-Subscriber Identity Module (SIM) signaling, EAP-Tunneled Transport Layer Security (TTLS) with Challenge Handshake Authentication Protocol (CHAP), etc. Optionally, the 3GPP AAA may respond with a RADIUS accept message. As part of the authentication of step 401, the RG may receive a subscription ID associated with the visiting host, for example from the 3GPP AAA, the PCRF, and/or the SPR. The subscription ID may comprise, for example, an International mobile Subscriber Identity (IMSI) user name. At step 405, the RG may assign an IPv6 address to the visiting host based on the IPv6 prefix assigned to the RG. The IPv6 address may be assigned by employing Dynamic Host Configuration Protocol (DHCP) version 6 (DHCPv6) and/or Stateless address autoconfiguration (SLAAC).

At step 407, the RG may register the IP address assigned to the visiting host by transmitting an address registration request to the IP edge. The address registration request may comprise the IPv6 address and a host ID associated with the visiting host. The host ID may comprise the visiting host's subscription ID, and/or a media access control (MAC) associated with the visiting host. For example, when DHCPv6 is employed at step 405, the RG may detect a DHCPv6 address request from the visiting host, and may detect the visiting host MAC address from the DHCP request and/or from any transmitted traffic. The RG may bind the MAC address with the visiting host's subscription ID, may send the subscription ID as the host ID when the binding is successful and send the MAC address as the host ID when binding is not successful. In some embodiments, both the MAC address and the subscription ID may be sent as the host ID.

At step 409, the IP edge may bind the host ID (e.g., MAC address of the host), IPv6 address, a line ID associated with the link and/or interface connecting the RG to the IP edge, and the subscription ID of the user (e.g. IMSI, username) from step 401 and communicate such data to the PCRF. For example, the IP edge may transmit an IP-CAN session establishment request message to the PCRF, in a manner similar to step 305 of method 300. The IP-CAN session establishment request message may comprise the subscription ID (e.g. of the RG or of the visiting host), the IPv6 prefix of the RG, the line ID, the host ID, and/or the IPv6 address of the visiting host. The line ID may be employed to associate the visiting host to the RG when a plurality of RGs are coupled to the IP edge, and may be detected by the IP edge based on the line from which the registration request of 407 is received. Depending on the embodiment, the IP-CAN session establishment request message may request a separate IP-CAN session for the visiting host or may request the creation of an IP-CAN sub-session of the IP-CAN session with the RG created in method 300. At step 411, the PCRF may make a policy decision (e.g. based on data from the SPR) in a manner similar to steps 307 and/or 309 of method 300. At step 413, the PCRF may transmit an IP-CAN session establishment acknowledgement message to the IP edge to indicate establishment of the IP-CAN sessions/sub-session. The acknowledgement message may comprise the IPv6 address, host ID, and/or line ID, as well as any management parameters related to the IP-CAN session, such as QoS requirements.

At step 415, the IP edge may transmit an address registration reply to the RG. The address registration reply may comprise the IPv6 address of the visiting host and/or the visiting host's host ID. It should be noted that in some embodiments, the reply of step 415 may instead be transmitted after step 407 and before step 409. At step 417, the IP edge may perform admission control and/or policy enforcement (e.g. QoS enforcement) for the visiting host independently from all other hosts attached the RG. For example, the IP edge may separately store the QoS parameters received for the RG (e.g. at step 311 of method 300), the visiting host (e.g. at step 413), and/or any other QoS parameters received for other hosts in the local network, such as the local host. The IP edge may then manage the QoS for each host independently by independently managing each hosts IP-CAN session/sub-session, and/or may report any QoS related events to the PCRF on a per host basis. As such, method 400 may allow fine grain QoS decisions to be made on a per host basis instead of applying all QoS decisions on a per RG and/or per local network level. Further, by employing method 400, IP CAN session management may apply to any device with a credential and may not be limited solely to 3GPP devices with a SIM card.

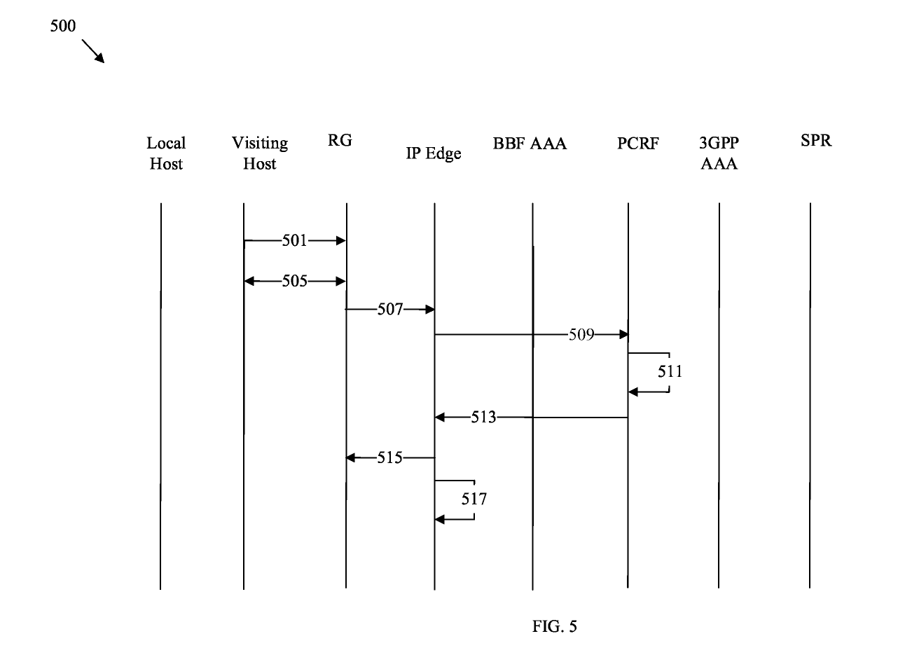

FIG. 5 is a protocol diagram of an embodiment of a method of IP-CAN session establishment for a visiting host performed without host authentication, for example in the case that the visiting host does not comprise a SIM card, and which may be implemented in a network such as network 100. For example, method 500 may be employed by a network comprising a local host, a visiting host, an RG, an IP edge, a BBF AAA, a PCRF, a 3GPP AAA, and an SPR, which may be substantially similar to local host 111, visiting host 112, RG 115, IP edge 123, BBF AAA 125, PCRF 137, 3GPP AAA 135, and SPR 139, respectively. Method 500 may occur after method 300, and may be substantially similar to method 400, but may be employed when the visiting host is not authenticated upon attachment to the local network. At step 501, the visiting host may attach to the RG without authentication. Accordingly, the IP edge and the RG may not be aware of the subscription ID of the visiting host (e.g. as the subscription ID may be sent to the IP edge in method 400 as part of the omitted authentication process of step 401). Step 505 may be substantially similar to step 405. At step 507, the RG may transmit an address registration request to the IP edge in a manner similar to step 407, buy may set the host ID to the MAC address of the visiting host as the subscription address may not be available. The line ID may be employed by the IP edge to identify the address registration request without the subscription ID. At step 509, the IP edge may transmit an IP-CAN session establishment request message to the PCRF in a manner substantially similar to step 409, and may set the subscription ID of the request to the MAC address of the visiting host. In an alternate embodiment, the subscription ID may be set to null, and the host ID may be employed to establish the IP-CAN session/sub-session. Steps 511 and 513 may be substantially similar to steps 411 and 413. At step 515, the IP edge may transmit the address registration reply in a manner similar to step 415, and may employ the MAC address as the host ID as the subscription ID may be unavailable. Step 517 may be substantially similar to step 417. By employing method 500, the IP edge may be unable to enforce QoS based on host subscriptions, but may consider line and/or RG QoS and may apply different QoS for each host for special requests to the PCRF server (e.g. for voice of IP multimedia subsystem (IMS)).

In some embodiments, at step 507 the RG may transmit the MAC address of the visiting host as one of several parameters in the host ID. In such a case, the IP edge may instead transmit an IP-CAN session modification request at step 509 and receive an IP-CAN session modification acknowledgement at step 513. In such an embodiment, the IP-CAN session/sub-session of the visiting host may be linked to the IP-CAN session of the RG. As such, the IP-CAN session may be modified on visiting host disconnect instead of terminated.

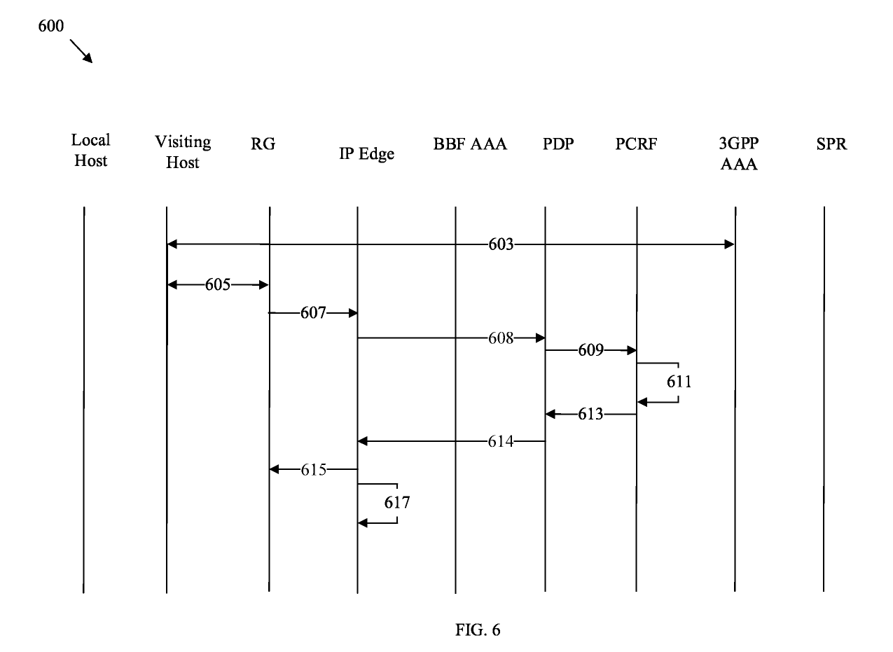

FIG. 6 is a protocol diagram of an embodiment of a method of IP-CAN session establishment for a visiting host performed via a BPCF PDP node, which may be implemented in a network such as network 100. For example, method 600 may be employed by a network comprising a local host, a visiting host, an RG, an IP edge, a BBF AAA, a PCRF, a 3GPP AAA, and an SPR, which may be substantially similar to local host 111, visiting host 112, RG 115, IP edge 123, BBF AAA 125, PCRF 137, 3GPP AAA 135, and SPR 139, respectively. Method 600 may be substantially similar to method 400, but may be employed when policy decisions and/or authentication in the fixed access network are performed by the PDP (e.g. based on data from the PCRF). Steps 603, 605, and 607 may be substantially similar to steps 401, 405, and 407, respectively. At step 608, the IP edge may transmit a BBF session establishment request message to the PDP. The BBF session establishment request message may comprise the host ID (e.g. visiting host MAC and/or subscription ID), IPv6 address, and/or RG line ID. At step 609, the PDP may transmit an IP-CAN session establishment request message to the PCRF, in a manner similar 409. Step 611 may be substantially similar to step 411. At step 613, the PCRF may transmit an IP-CAN session establishment acknowledgement message to the PDP in a manner substantially similar to step 413. At step 614, the PDP may transmit a BBF session establishment acknowledgement message to the IP edge. The BBF session establishment acknowledgement message may comprise the host ID, IPv6 address, and/or line ID from step 608. Steps 615 and 617 may be substantially similar to steps 415 and 417, respectively.

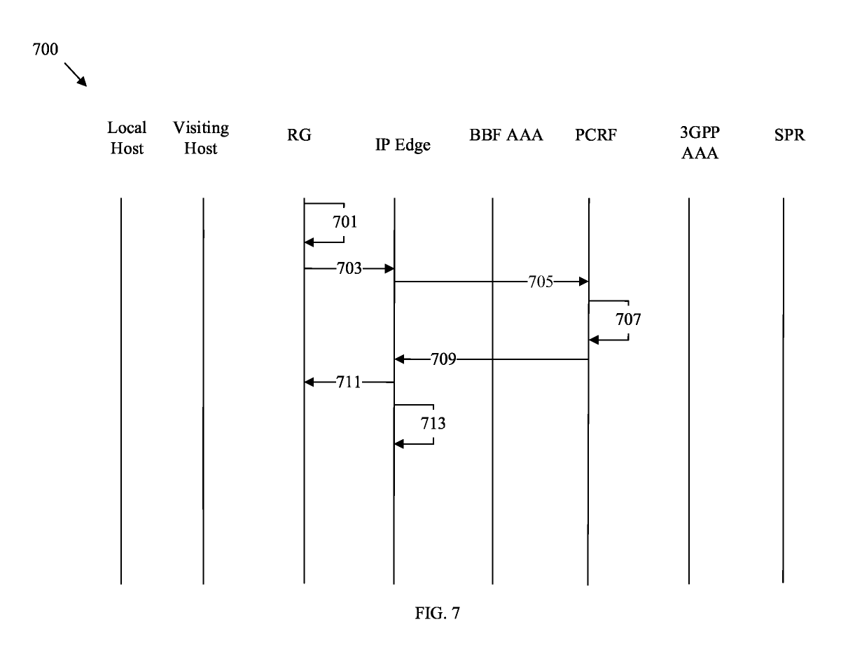

FIG. 7 is a protocol diagram of an embodiment of a method 700 of IP-CAN session termination by an RG, which may be implemented in a network such as network 100. For example, method 700 may be employed by a network comprising a local host, a visiting host, an RG, an IP edge, a BBF AAA, a PCRF, a 3GPP AAA, and an SPR, which may be substantially similar to local host 111, visiting host 112, RG 115, IP edge 123, BBF AAA 125, PCRF 137, 3GPP AAA 135, and SPR 139, respectively. Method 700 may be employed to terminate an IP-CAN session/sub-session created by methods 400, 500, and/or 600. At step 701, an RG may detect that a visiting host has disconnected from the local network. At step 703, the RG may transmit an indication of host disconnection to the IP edge to terminate the registration associated with the visiting RG. The indication of host disconnection may be substantially similar to an address registration request (e.g. the address registration request messages of steps 407, 507, and/or 607), but may be employed to remove a registration of an IPv6 address and/or terminate an IP-CAN session/sub-session. At step 705, the IP edge may determine which IP-CAN session/sub-session associated is with the visiting host and may transmit an IP-CAN session termination request to the PCRF. The IP-CAN session termination request may be substantially similar to the IP-CAN session establishment request messages of steps 409, 509, and/or 609, but may be employed to terminate an IP-CAN session/sub-session. At step 707, the PCRF may identify the policy and charging rules affected by the termination of the session/sub-session. At step 709, the PCRF may transmit an IP-CAN session termination acknowledgement to the IP edge. The IP-CAN session termination acknowledgement may be substantially similar to the IP-CAN session establishment acknowledgement messages of steps 413, 513, and/or 613, but may be employed to acknowledge the termination of an IP-CAN session/sub-session. At step 711, the IP edge may transmit an address termination acknowledgement to the RG. The address termination acknowledgement message may be substantially similar to the address registration reply messages of steps 415, 515, and/or 615, but may acknowledge the termination of the visiting host IPv6 address. At step 713, the IP edge may remove all rules relevant to the visiting host.

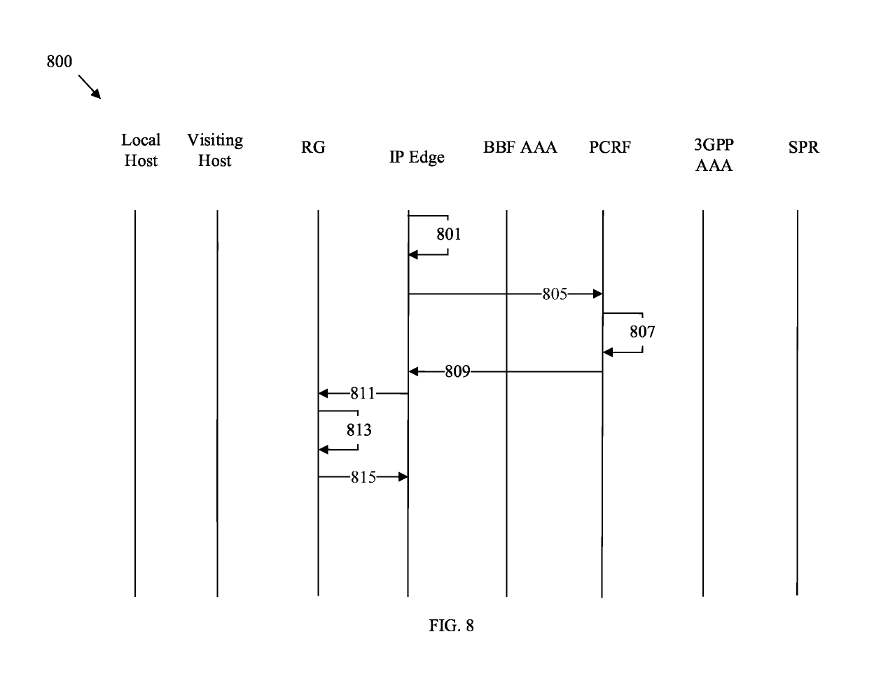

FIG. 8 is a protocol diagram of an embodiment of a method 800 of IP-CAN session termination by an IP edge node, which may be implemented in a network such as network 100. For example, method 800 may be employed by a network comprising a local host, a visiting host, an RG, an IP edge, a BBF AAA, a PCRF, a 3GPP AAA, and an SPR, which may be substantially similar to local host 111, visiting host 112, RG 115, IP edge 123, BBF AAA 125, PCRF 137, 3GPP AAA 135, and SPR 139, respectively. Method 800 may be similar to method 700, but may be employed when the IP edge detects a disconnection from a visiting host. At step 801, the IP edge may determine that a visiting host has disconnected from the local network. Steps 805, 807, and 809 may be substantially similar to steps 705, 707, and 709, respectively. At step 811, the IP edge may transmit an indication of host disconnection to the RG in a manner similar to step 703. At step 813, the RG may release all resources allocated to the visiting host. At step 815, the RG may transmit an address termination acknowledgement message to the IP edge in a manner similar to step 711. It should be noted that steps 805, 807, and 809 may be executed in parallel with steps 811, 813, and 815. The network may then take any additional termination steps required by BBF and/or 3GPP standards.

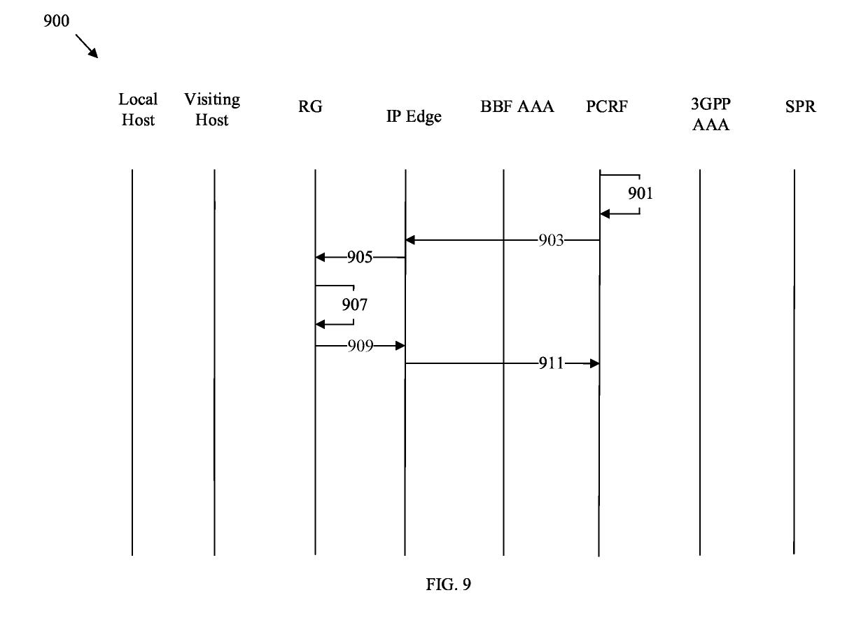

FIG. 9 is a protocol diagram of an embodiment of a method 900 of IP-CAN session termination by a PCRF node, which may be implemented in a network such as network 100. For example, method 900 may be employed by a network comprising a local host, a visiting host, an RG, an IP edge, a BBF AAA, a PCRF, a 3GPP AAA, and an SPR, which may be substantially similar to local host 111, visiting host 112, RG 115, IP edge 123, BBF AAA 125, PCRF 137, 3GPP AAA 135, and SPR 139, respectively. Method 900 may be similar to methods 700 and 800, but may be employed when the PCRF detects a disconnection from a visiting host. Further, method 900 may be triggered by an external application function providing service to the visiting host, by expiring of credit for online charging, etc. At step 901, the PCRF may determine that a visiting host has disconnected from the local network. At step 903, the PCRF may transmit an IP-CAN session termination request to the IP edge in a manner similar to step 805. Steps 905, 907, and 909 may be substantially similar to steps 811, 813, and 815, respectively. At step 911, the IP edge may transmit an IP-CAN session termination acknowledgement message to the PCRF in a manner similar to step 809. The network may then perform IP-CAN session termination steps as discussed in 3GPP TS 23.203 and TS 29.213.

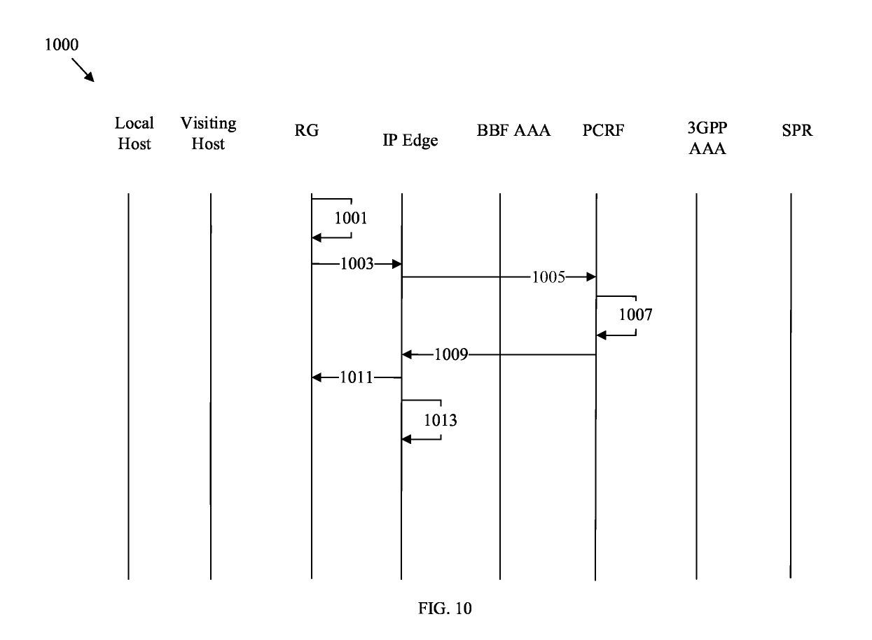

FIG. 10 is a protocol diagram of an embodiment of a method 1000 of IP-CAN session/sub-session modification, which may be implemented in a network such as network 100. For example, method 800 may be employed by a network comprising a local host, a visiting host, an RG, an IP edge, a BBF AAA, a PCRF, a 3GPP AAA, and an SPR, which may be substantially similar to local host 111, visiting host 112, RG 115, IP edge 123, BBF AAA 125, PCRF 137, 3GPP AAA 135, and SPR 139, respectively. Method 1000 may be employed when the hosts in the local network employ a sub-session of an RG session such that a global termination of the IP-CAN session in response to a visiting host disconnect is undesirable. Steps 1001, 1003, 1005, 1007, 1009, 1011, and 1013 may be substantially similar to step 701, 703, 705, 707, 709, 711, and 713. However, in step 1005, the IP edge may transmit an IP-CAN session modification request instead of an IP-CAN session termination request. The IP-CAN session modification request may set the subscription ID to the line ID and may omit the line ID field employed by the IP-CAN session termination request. Further, at step 1009, the PCRF may transmit an IP-CAN session modification acknowledgement instead of an IP-CAN session termination acknowledgement. Accordingly, by modifying the RG session to remove the IP-CAN sub-session associated with the visiting host, the IP-CAN session/sub-sessions associated with the RG and other hosts in the local network may continue undisturbed by the disconnection of the visiting host.

FIG. 11 is a schematic diagram of an embodiment of an address registration request 1100 TLV encoding, which may be employed as an address registration request message between an RG and an IP edge, such as RG 115 and IP edge 123, respectively. For example, request 1100 may be employed in the address registration request messages of steps 407, 507, 607, 703, 811, 905, and 1003. The address registration request 1100 may comprise a Type field 1110, which may be eight bits in length, may extend from the zero bit position to the seventh bit position, and may be set to a value to indicate that the request 1100 is an address registration request 1100. The request 1100 may further comprise a Length field 1120, which may be eight bits in length, may extend from the eighth bit position to the fifteenth bit position, and may be set to a value to indicate the length of the request 1100 in units of octets. For example, the Length field 1120 may be set to a value of about eight or about twenty. The request 1100 may further comprise a Sequence number field 1130, which may be sixteen bits in length, may extend from the sixteenth bit position to the thirty first bit position, and may comprise a sequence value that may be used by an access router (e.g. AN 121) to process requests from the RG in sending order. The request 1100 may further comprise a parameters field 1140, which may comprise any parameters carried by the request message 1100 in TLV format. For example, parameters field 1140 may comprise IPv6 addresses, IPv4 addresses, IPv6 prefixes, IPv4 prefixes, host IDs, MAC addresses, subscription IDs, etc.

FIG. 12 is a schematic diagram of an embodiment of an address parameter 1200 TLV encoding, which may be employed as a parameter in parameters field 1140. Address parameter 1200 may comprise a Type field 1210, which may be eight bits in length, may extend from the zero bit position to the seventh bit position, and may be set to a value to indicate that the parameter is an address parameter 1200. Address parameter 1200 may further comprise a Length field 1220, which may be eight bits in length, may extend from the eighth bit position to the fifteenth bit position, and may be set to a value to indicate the length of the address parameter 1200 in units of octets. For example, the Length field 1220 may be set to a value of about six or about eighteen. Address parameter 1200 may further comprise an address field 1230, which may be of variable length may extend from the sixteenth bit position, and may comprise an IPv4 or an IPv6 address.

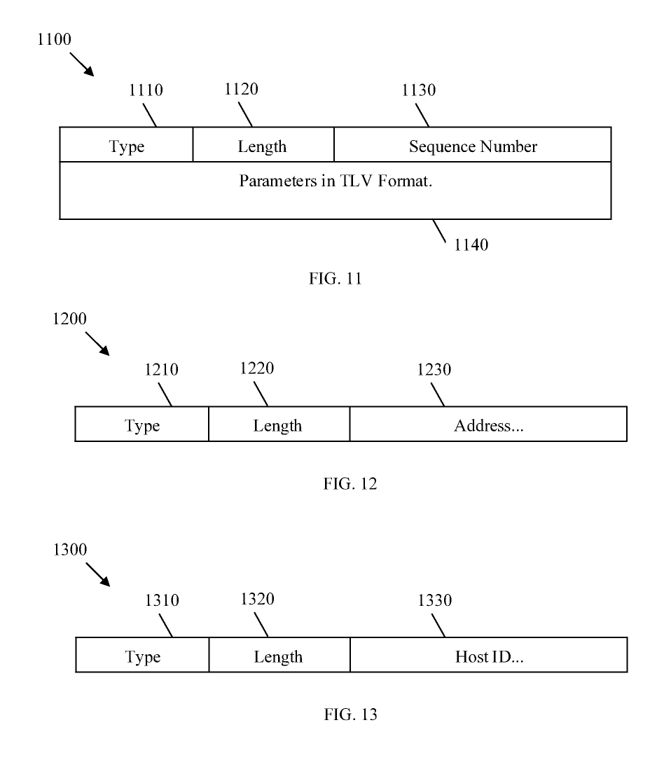

FIG. 13 is a schematic diagram of an embodiment of a host ID parameter 1300 TLV encoding, which may be employed as a parameter in parameters field 1140. Host ID parameter 1300 may comprise a Type field 1310, which may be eight bits in length, may extend from the zero bit position to the seventh bit position, and may be set to a value to indicate that the parameter is a host ID parameter 1300. Host ID parameter 1300 may further comprise a Length field 1320, which may be eight bits in length, may extend from the eighth bit position to the fifteenth bit position, and may be set to a value to indicate the length of the host ID parameter 1300 in units of octets. For example, the Length field 1320 may be set to a value of about three or more. Host ID parameter 1300 may further comprise a Host ID field 1330, which may be of variable length may extend from the sixteenth bit position, and may comprise any host ID as described herein, for example in root Network Access Identifier (NAI) format.

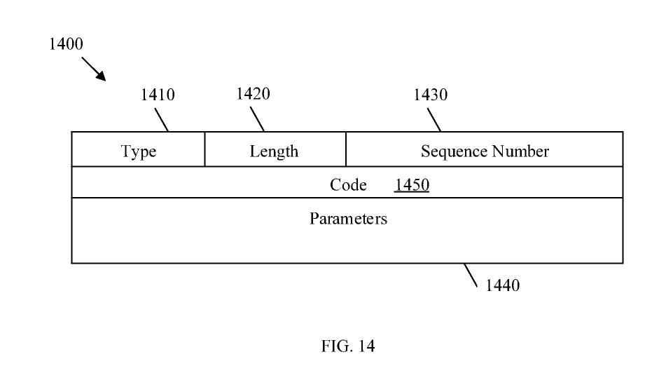

FIG. 14 is a schematic diagram of an embodiment of an address registration reply 1400 TLV encoding, which may be employed as an address registration reply message between an RG and an IP edge, such as RG 115 and IP edge 123, respectively. For example, reply 1400 may be employed in the address registration reply messages of steps 415, 515, 615, 711, 815, 909, and 1101, The address registration reply 1400 may comprise a Type field 1410, which may be eight bits in length, may extend from the zero bit position to the seventh bit position, and may be set to a value to indicate that the reply 1400 is an address registration reply 1400. The address registration reply 1400 may further comprise a Length field 1420, which may be eight bits in length, may extend from the eighth bit position to the fifteenth bit position, and may be set to a value to indicate the length of the request 1400 in units of octets. For example, the Length field 1420 may be set to a value of about eight, about twelve, or about twenty four. The reply 1400 may further comprise a Sequence number field 1430, which may be sixteen bits in length, may extend from the sixteenth bit position to the thirty first bit position, and may comprise a sequence value that may match the sequence value of a corresponding address registration request, such as request 1100. The reply 1400 may further comprise a code field 1450, which may be thirty two bits in length, may extend from the zero bit position to the thirty first bit position, and may comprise a value to indicate the result of the corresponding address registration request. For example, a value of zero may indicate a successful request, while a non-zero value may indicate a failure, an error code, etc. The reply 1400 may further comprise an optional parameters field 1440, which may comprise be substantially similar to optional parameters field 1140.

In summary of the material discussed above, as part of Fixed Mobile Convergence (FMC) standardization, convergence or Policy for Convergence (P4C) may be considered. P4C may deal with applying 3GPP Policy and Charging Control (PCC) to hosts in a fixed IP network, including hosts accessing the fixed IP network from home and/or from a public Institute of Electrical and Electronics Engineers (IEEE) 802.11 (WiFi) network. A problem may occur when more than one host is assigned IPv6 addresses by a local device, e.g. RG, and share the same IPv6 prefix without interaction with the Edge router where the PCC interface is terminated. In such a case, PCC may not apply host specific QoS for each host.

When a host, e.g. Local_Host_{—}1 attaches to a routed RG, the RG may use DHCPv6 Prefix Delegation as Requesting Router (RR) to request a prefix, possibly of size /64 for a home network. The edge router may act as a Delegating Router (DR), and may assign the IPv6 prefix to the RG. The host may be both a 3GPP host and a Fixed device, e.g. an PC, IP television (IPTV), set top box (STB), etc. The edge router may next initiate an IP Connectivity Access Network (IP-CAN) session with the policy server, e.g. Policy and Charging Rules Function (PCRF) to receive the QoS parameters. The edge router may provide the IPv6 Prefix and host ID, which in this case may be equal to the home network line ID. IP-CAN session establishment may complete when the policy server sends an IP-CAN session establishment acknowledgement to the RG. The edge router may bind the IP subscriber session for the RG with the IP-CAN session identified by RG ID, IPv6 Prefix. The edge router may apply admission control and quality of service policy based on the parameters received from the policy server during the IP-CAN session establishment.

A 3GPP host may be authenticated. In this case, EAP-based authentication method (such as EAP-SIM or EAP-AKA) may be used, with RG as the authenticator with the AAA server in the 3GPP network. At the end of a successful authentication, the host may receive its host id, e.g. NAI in User-Name attribute. Host id may contain and IMSI and may be in Root NAI format. Root NAI may take the form of “0IMSI@nai.epc.mncMNC.mccMCC.3gppnetwork.org” for EAP AKA authentication, e.g. if the IMSI is 234150999999999 (mobile country code (MCC)=234, mobile network code (MNC)=15), the root NAI may then take the form of 0234150999999999@nai.epc.mnc015.mcc234.3gppnetwork.org for EAP AKA authentication.

In case of stateless address auto configuration, the host may send a router solicitation message to the RG and the RG may send a Router Advertisement with an IPv6 prefix, which may be the home network prefix. The host may create an 128-bit IPv6 address using this prefix and adding its interface id. Having completed the address configuration, the host may start communication with the Internet to use the Internet services. Another host, e.g. a non-3GPP visiting host, may attach to the RG and may also establish an IPv6 address using the home network prefix. The edge router may not be involved in such address assignments. In this case no authentication is may be performed, so the host may not receive a host id from the 3GPP network.

The above operation may assume that stateless address auto configuration (SLAAC) is used. DHCPv6 based stateful address assignment may also be used. In case of a routed RG, the RG may be a DHCPv6 relay agent communicating with a DHCPv6 server in the operator's IP network. The DHCPv6 server, in assigning IPv6 addresses to the hosts, may use a method where /64 prefixes are not shared between hosts in different home networks. The RG may not signal to the edge router the IPv6 address assigned to a host, e.g. visiting host, so the edge router acting as a PCEF may not be able to start an 3GPP IP-CAN session for the given host ID, IPv6 Address corresponding to each single host, e.g. the local host and/or visiting host.

Each host in the home network may create an IPv6 address which is global and such address may be used to identify the hosts traffic and may enable the PCEF to enforce the proper QoS after establishing an IP-CAN session to download the associated parameters. The host id given to the mobile network may be the home network line id which may be the same for all the hosts in the home network.

In the first phase of the solution, for a 3GPP host, RG may send an IPv6 address of the host and the host id as received from 3GPP network during authentication in an Address Registration Request message to the edge router. The timing of this message could be after SLAAC is completed, e.g. after sending a neighbor solicitation message with the Target Address being set to the address being checked, in which case the Target Address may be the address that the RG sends. The timing of this message could also be after the DHCPv6 address configuration is completed, in which case the IPv6 address in an Identity Association (IA) Address option (OPTION_IAADDR) may be the address that the RG sends. After receiving the first unicast packet from the host, in this case, the source address of the packet may be the address that the RG sends. The RG may receive an Address Registration Reply message and may check the code. If the value of the code is zero then the request may have succeeded.

After the address registration at the edge router, the edge router may communicate with the policy server and get the quality of service parameters for each host separately. For this purpose the edge router may establish an IP-CAN session separately for each host or an IP-CAN sub-session portion of the main session the RG has established with the policy server. For a 3GPP host, during IP-CAN session/sub-session establishment, the edge router may include the IMSI as part of the host id. The edge router may also send the IPv6 address as a parameter.

In case of non-3GPP hosts, during IP-CAN session/sub-session establishment, the edge router may include an RG-ID and/or line id, an IPv6 address, and/or an IPv6 prefix. The policy server may obtain the subscriber's profile related to the host. The policy router may send the default QoS of the subscriber and some other information to the edge router. An IP-CAN session/sub-session may be established between the edge router and the policy server. Over this session, the policy server may be informed about quality of service related events. The session may remain open until the session is removed as requested by the edge router. The edge router may repeat the above procedures for each host that shares the address/prefix.

The RG may first use the address registration message exchange to register the addresses of the hosts sharing the prefix. The edge router may establish an IP-CAN session with the policy router for each such host. The edge router may get QoS parameters for each host. The edge router may enforce the QoS for each host in the active traffic. When the hosts disconnect or leave the network, the edge router may terminate the IP-CAN session/sub-session for each host. These messages may be sent with a User Datagram Protocol (UDP) packet header and may contain the parameters discussed herein. All parameters may be TLV formatted.

The address registration request message may be sent by the RG. The Address registration request message may contain IPv6 and/or IPv4 addresses. The address field can be replicated to register more than one address. The RG may employ a different sequence number into each new address request message sent to the edge router.

The address registration reply messages may be sent by the edge router. The edge router may set the sequence number field to the value in the request message. The code may be set according to the success of the address request message.

When an address registration protocol is used between the residential gateway and the edge router, there may be no need for additional security mechanisms. This may be because the RG to edge router communication may employ a secured tunnel (e.g. IP Security (IPSEC) and/or other mechanisms). When address registration protocol is used between the residential gateway and a generic server such as a web server, the protocol may be secured. A Datagram Transport Layer Security (DTLS) protocol can be used to secure the address registration protocol. DTLS may be a Transport Layer Security (TLS) version 1.2 over datagram transport. A DTLS handshake protocol may start with a stateless cookie exchange in which the client, Residential Gateway sends a ClientHello message and the server replies with a HelloVerifyRequest message which contains a cookie. The client may send another ClientHello, this time with the cookie. This phase may allow the server to verify the cookie is valid and that the client can receive packets at the given IP address.

DTLS handshake protocol may continue with essentially the same TLS exchanges such as ServerHello, Certificate, ServerKeyExchange, CertificateRequest and ServerHelloDone messages by the server and Certificate, ClientKeyExchange, CertificateVerify and Client Finished messages. With these messages, the client and server may exchange signed certificates, authenticate each other and select a cipher suite to be used to secure the communication between the two. The server may reply with ChangeCipherSpec to notify the client that subsequent records may be protected under the newly negotiated CipherSpec and keys and Server finished message which may terminate the full handshake.

A DTLS session-resuming handshake, which may be executed after the keys expire, may be much simpler. The client may send a Client Hello, to which the server may reply with a ServerHello, a ChangeCipherSpec, and a Finished message. The client may send a ChangeCipherSpec and a Finished message to complete the handshake.

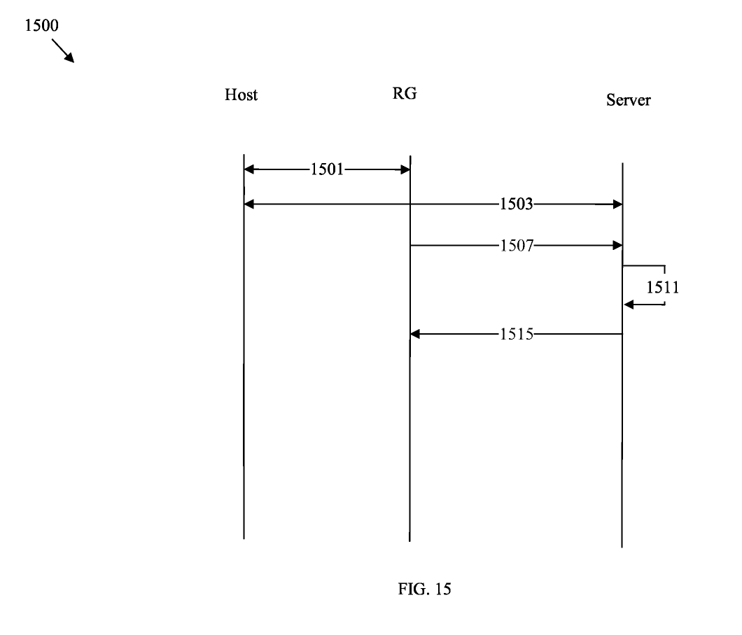

FIG. 15 is a protocol diagram of an embodiment of a method of IPv4/IPv6 address sharing. Method 1500 may be implemented on a network similar to network 100. For example, in network 100, upstream network 140 may comprise a server, such as a call server, web server, File Transfer Protocol (FTP) server, etc. The server may be unaware of the IP address of a host (e.g. visiting host 112). For example, the RG (e.g. RG 115) may comprise a network address translation (NAT) function, for example in an IP version four (IPv4) and/or IPv6 local network (e.g. fixed local network 110). In such a network, the server may only be aware of the IP address of the RG and not the IP addresses of the hosts attached to the RG. Method 1500 may be employed by the RG to inform the server of the IP address of the host.

At step 1501, the host may join the local network. The RG may assign an IP address to the host in the local network address spec. For example, the RG may assign an IPv4 or an IPv6 address to the host, depending on the embodiment. At step 1503, the host may initiate a communication with the server, such as a transport connection, and initiate an application. For example, the host may initiate an emergency call, a web based application, an FTP download, etc. In a network with a NAT function, the server may receive packets with the RG's address as the source, but may be unaware of the address assigned to the host. At step 1507, the RG may transmit an address registration request on behalf of the host in a manner similar to step 407. At step 1511, the server may make appropriate policy decisions that are specific to the host. For example, the server may be able to grant an emergency priority to the host while giving a lower priority to other hosts attached to RG. The server may then manage the communications of step 1503 based on the priority assigned to the host and not based on a general policy associated with the RG. At step 1515, the server may transmit an address registration reply to the RG in a manner similar to step 415 to indicate that the address of the host has been registered with the server. As noted above, the address registration of method 1500 may be employed to share an address of a host in either an IPv4 network or an IPv6 network in any scenario where the host's IP address is hidden from an upstream server (e.g. NAT based network, dual stack network, etc.).

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. The use of the term “about” means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A residential gateway (RG) positioned in a local fixed network, wherein the RG comprises:
at least one receiver configured to:
receive an Internet Protocol (IP) version six (IPv6) prefix; and
receive address requests from a plurality of hosts, wherein the plurality of hosts comprise a visiting 3rd Generation Partnership Project (3GPP) mobile host;
a processor coupled to the receiver and configured to allocate IPv6 addresses to each of the plurality of hosts based on the IPv6 prefix; and
at least one transmitter coupled to the processor and configured to transmit an address registration request to an IP edge node on behalf of the visiting host,
wherein the address registration request comprises the IPv6 address of the visiting host and an identifier assigned to the visiting host, and
wherein the identifier is not assigned to any other host in the local fixed network.

2. The RG of claim 1, wherein the identifier comprises a media access control (MAC) address associated with the visiting host, and wherein the receiver is further configured to receive the MAC address in a Dynamic Host Configuration Protocol (DHCP) request from the visiting host.

3. The RG of claim 1, wherein the RG is configured to:
participate in a 3GPP authentication protocol to authenticate the visiting host with a mobile network associated with the visiting host; and
receive, from the mobile network, a subscription identifier (ID) associated with the visiting host,
wherein the identifier of the address registration request comprises the subscription ID.

4. The RG of claim 1, wherein the receiver is further configured to receive an address registration reply from the IP edge node for the visiting host, wherein the address registration reply comprises the IPv6 address of the visiting host and the identifier of the visiting host, and wherein the address registration reply indicates successful registration of the visiting host IP address with the RG.

5. The RG of claim 1, wherein the receiver is further configured to receive an address registration reply from the IP edge node for the visiting host, wherein the address registration reply comprises the IPv6 address of the visiting host and the identifier of the visiting host, wherein the address registration reply initiates an establishment of an IP Connectivity Access Network (IP-CAN) session of an IP-CAN session associated with the RG, and wherein the IP-CAN session is associated with the visiting host and not associated with any other host in the local fixed network.

6. The RG of claim 5, wherein the identifier of the visiting host comprises a subscription identifier (ID) associated with the visiting host and received during an authentication procedure, a Media Access Control (MAC) address of the visiting host, an identifier of a line by which the host is connected to the RG, or combinations thereof.

7. The RG of claim 5, wherein the RG is configured to:
detect that the visiting host has disconnected from the RG; and
transmit an indication of host disconnection message to the IP edge node to request termination of the IP-CAN session associated with the visiting host,
wherein the indication of host disconnection message comprises the visiting host's IPv6 address and identifier.

8. The RG of claim 7, wherein the receiver is further configured to receive an address termination acknowledgement message indicating the termination of the IP-CAN session associated with the visiting host is successful, wherein the address termination acknowledgement message comprises the visiting host's IPv6 address and identifier.

9. A computer program product implemented in an Internet Protocol (IP) edge node positioned in a fixed access network, the computer program product comprising computer executable instructions stored on a non-transitory computer readable medium such that when executed by a processor cause the IP edge node to:
receive an address registration request from a residential gateway (RG), wherein the address registration request comprises an IP version six (IPv6) address of a visiting 3rd Generation Partnership Project (3GPP) mobile host connected to a local fixed network associated with the RG and an identifier assigned to the visiting host and not to any other host in the local fixed network;
establish an IP Connectivity Access Network (IP-CAN) sub-session for the visiting host; and
manage quality of service (QoS) for the visiting host independently of other hosts in the local fixed network by managing the visiting host IP-CAN session.

10. The computer program product of claim 9, wherein establishing the IP-CAN sub-session for the visiting host comprises transmitting an IP-CAN establishment message to a Policy and Charging Rules Function (PCRF) node, and wherein the IP-CAN establishment message comprises the IPv6 address of the visiting host and a line identifier (ID) that identifies a link between the IP-edge node and the RG.

11. The computer program product of claim 10, wherein the IP-CAN establishment message comprises a Subscription ID field, and wherein the Subscription ID field is set to a Media Access Control (MAC) address of the visiting host when the visiting host is not authenticated prior to transmission of the IP-CAN establishment message.

12. The computer program product of claim 10, wherein establishing the IP-CAN sub-session for the visiting host further comprises receiving an acknowledgment message from the PCRF node indicating establishment of the IP-CAN sub-session for the visiting host, and wherein the processor further causes the IP edge node to transmit an address registration reply to the RG, wherein the address registration reply comprises the IPv6 address of the visiting host and the identifier of the visiting host, and wherein the address registration reply indicates the establishment of the IP-CAN sub-session associated for the visiting host.

13. The computer program product of claim 9, wherein establishing the IP-CAN sub-session for the visiting host comprises transmitting a Broad Band Forum (BBF) session establishment message to a Broadband Policy Control Framework (BPCF) Policy Decision Point (PDP) node positioned in the fixed access network, and wherein the BBF session establishment message comprises the visiting host's identifier, the IPv6 address of the visiting host, and a line ID that identifies a link between the IP-edge node and the RG.

14. The computer program product of claim 9, wherein the processor further causes the IP edge node to:
receive an indication of host disconnection from the RG requesting termination of the visiting host IP-CAN sub-session; and
transmit an IP-CAN session termination message to a Policy and Charging Rules Function (PCRF) node based on the indication of disconnection, and
wherein the IP-CAN session termination message comprises the visiting host's identifier, the IPv6 address of the visiting host, and a line ID that identifies a link between the IP-edge node and the RG.

15. The computer program product of claim 9, wherein the processor further causes the IP edge node to establish an IP-CAN session for the RG prior to establishing an IP-CAN session for the visiting host, and wherein the visiting host IP-CAN session is established as a sub-session of the RG IP-CAN session.

16. The computer program product of claim 15, wherein the processor further causes the IP edge node to:
receive an indication of host disconnection from the RG requesting termination of the IP-CAN session associated with the visiting host; and
transmit an IP-CAN sub-session modification message to a Policy and Charging Rules Function (PCRF) node based on the received indication of host disconnection,
wherein the IP-CAN session modification message comprises the visiting host's identifier, the IPv6 address of the visiting host, and a line ID that identifies a link between the IP-edge node and the RG, and
wherein the IP-CAN session modification message indicates a request to terminate the visiting host IP-CAN session without terminating the RG IP-CAN session.

17. The computer program product of claim 9, wherein the processor further causes the IP edge node to:
detect that the visiting host has disconnected from the fixed access network;
transmit an IP-CAN session termination message to a Policy and Charging Rules Function (PCRF) node based on the detection of visiting host disconnection, wherein the IP-CAN session termination message comprises the visiting host's identifier, the IPv6 address of the visiting host, and a line ID that identifies a link between the IP-edge node and the RG; and
transmit an indication of host disconnection to the RG requesting a release of all resources allocated to the visiting host, and
wherein the indication of host disconnection comprises the visiting host's identifier and the visiting host IPv6 address.

18. The computer program product of claim 9, wherein the processor further causes the IP edge node to receive an IP-CAN session termination message from a Policy and Charging Rules Function (PCRF) node, wherein the IP-CAN session termination message comprises the visiting host's Subscription ID, the IPv6 address of the visiting host, and a line ID that identifies a link between the IP-edge node and the RG.

19. A method implemented in an edge router, wherein the method comprises:
assigning an Internet Protocol (IP) version six (IPv6) prefix to a routed residential gateway (RG);
authenticating a 3rd Generation Partnership Project (3GPP) host connected to the RG with a 3GPP network to receive a host identifier (ID) from the 3GPP network;
receiving, from the RG, an address registration request message comprising an IPv6 address of the 3GPP host based on the IPv6 prefix and the Subscription ID;
after address registration, communicating with a Policy and Charging Rules Function (PCRF) server to get separate Quality of Service (QoS) parameters for each host connected to the RG by establishing an IP Connectivity Access Network (IP-CAN) sub-session for each host as part of a main IP-CAN session between the RG and the PCRF server; and
enforcing QoS in active traffic for each host connected to the RG.

20. The method of claim 19, further comprising informing the PCRF server about QoS events over the IP-CAN sub-sessions.

21. The method of claim 19, further comprising transmitting an address registration reply to the RG to indicate that address registration has succeeded.

22. A method implemented in a residential gateway (RG) positioned in a local fixed network, wherein the method comprises:
receiving a communication from a host connected to the local fixed network directed toward a server in an upstream network;
forwarding the communication toward the server by employing an Internet Protocol (IP) address associated with RG as the source of the communication; and
transmitting an address registration request, separate from the host communication, to the server to register an IP address of the host with the server, wherein the address registration request comprises the host IP address and an identifier associated with the host.

23. The method of claim 22, further comprising receiving an address registration reply from the server indicating that the host IP address is registered with the server, wherein the address registration reply comprises the host IP address and identifier.

24. The method of claim 23, wherein the identifier is a subscription identifier (ID).

25. The method of claim 23, wherein the local fixed network is an IP version four (IPv4) network, and wherein the upstream network is an IP version six (IPv6) network.
